(19) United States
(12) Patent Application Publication
(10) Pub. No.: US 2025/0196920 A1
(43) Pub. Date: Jun. 19, 2025

(54) METHOD FOR STEERING CONTROL OF AN ARTICULATED CONSTRUCTION MACHINE, IN PARTICULAR A SELF-PROPELLED GROUND COMPACTION MACHINE, IN PARTICULAR A SINGLE-DRUM ROLLER OR A TANDEM ROLLER, BY MEANS OF A STEERING CONTROL UNIT, AND ARTICULATED CONSTRUCTION MACHINE, IN PARTICULAR SELF-PROPELLED GROUND COMPACTION MACHINE

(71) Applicant: BOMAG GMBH, Boppard (DE)

(72) Inventors: Eike BEUL, Boppard (DE); Niels LAUGWITZ, Boppard (DE)

(21) Appl. No.: 18/969,950

(22) Filed: Dec. 5, 2024

(30) Foreign Application Priority Data
Dec. 13, 2023 (DE) 10 2023 135 043.9

(51) Int. Cl. B62D 12/00

(52) U.S. Cl. CPC B62D 12/00

(57) ABSTRACT

A method for steering control of an articulated construction machine, in particular a self-propelled ground compaction machine, in particular a single-drum roller or a tandem roller, by means of a steering control unit, and to an articulated construction machine, in particular a self-propelled ground compaction machine.

### FIELD

The invention relates to a method for steering control of an articulated construction machine, in particular a self-propelled ground compaction machine, in particular a single-drum roller or a tandem roller, by means of a steering control unit. The invention further relates to an articulated construction machine, in particular a self-propelled ground compaction machine.

### BACKGROUND

Articulated construction machines are known and are characterized by the fact that they have a front carriage and a rear carriage, which are connected to each other via an articulated joint device so as to be steerable relative to each other. The steering axis usually extends in a vertical direction, but may also be inclined with respect to a vertical axis. At least one travel unit, for example in the form of one or more wheels or one or more roller drums, is arranged on the front carriage and the rear carriage. In articulated machines, these travel units are often not steerable relative to the front and rear carriages supporting them, but can only be rotated about a rotation axis that is usually horizontal and transverse to a forward direction of the construction machine. Steering movements of such construction machines are achieved by rotating the relative position of the front carriage relative to the rear carriage about the steering axis of the articulated joint device.

The articulated joint device may also be configured such that the front carriage can oscillate relative to the rear carriage about an oscillating axis extending in the forward direction. In this way, the at least one travel unit of the front carriage and the at least one travel unit of the rear carriage can rotate relative to each other about the oscillating axis, which means that uneven ground can be compensated for, for example, or that loads can be evenly distributed on the underlying ground even if the ground is uneven. The oscillating axis thus runs in an essentially horizontal plane in the forward direction of the construction machine traveling straight ahead.

Furthermore, it is also known to connect the front carriage and the rear carriage to one another with the aid of a crab steering device such that the track of the at least one travel unit of the front carriage can be displaced horizontally and at an angle to the direction of travel, or translationally in the horizontal plane, relative to the track of the at least one travel unit of the rear carriage. In this so-called crab steering mode, for example, if the travel units are roller drums, the entire working width of the machine can be increased in the forward direction, in which case only an inner part of the overall track is driven over by both roller drums and there is an edge region surrounding this inner part on both sides to the outer sides, in which the ground is only driven over by one roller drum at a time. The crab steering joint device may be configured such that the crab steering adjustment takes place along a linear adjustment axis or along a curve or curved path. Such a coupling device for a tandem roller is known, for example, from applicant's EP 2 423 076 B1. Further self-propelled construction machines with an articulated joint device and a crab steering joint device are also described in DE 8209885 U1 and U.S. Pat. No. 6,345,832 B1.

An adjustment drive, for example in the form of one or more hydraulic cylinders or other actuators, may be provided to drive a steering adjustment via the articulated joint device and a translational adjustment via the crab steering joint device.

The terms “adjustment axis”, “articulated joint axis” and “pendulum joint axis” denote movement axes and not necessarily component axes.

Even though self-propelled construction machines with a front carriage with a first travel unit, a rear carriage with a second travel unit, an articulated pendulum joint device connecting the front carriage to the rear carriage with an articulated joint steering axis and an pendulum joint oscillating axis and with a crab steering joint device for translational adjustment of the front carriage relative to the rear carriage have already proven their worth, there is still potential for optimization. For example, the tipping resistance of such construction machines can be challenging, especially at comparatively high travel speeds and large steering angles. Furthermore, increasing the steering angle partially shifts the load distribution on the at least one travel unit of the front carriage and/or the rear carriage. This can be particularly disadvantageous if the working function of the construction machine consists in a load transfer via the at least one travel unit into the underlying ground, as is the case, for example, with ground compaction machines that comprise one or more roller drums. In such cases, grooves can be made in the surface of the underlying ground when cornering, especially with increased steering angles, due to the load no longer being evenly distributed across the width of the respective roller drum, which can result in considerable reworking.

### SUMMARY

It is therefore an object of the invention to provide a way of further improving the handling of generic construction machines as known in the prior art.

This object is achieved with a method for steering control of an articulated construction machine, in particular a self-propelled ground compaction machine, in particular a single-drum roller or a tandem roller, by means of a steering control unit, and with an articulated construction machine according to the independent claims. Preferred embodiments are cited in the dependent claims.

In a first aspect, the invention thus relates to a method for steering control of an articulated construction machine. A construction machine provided for implementing the method according to the invention comprises a front carriage with at least one first travel unit and a rear carriage with at least one second travel unit. The front carriage comprises a front carriage machine frame and the rear carriage comprises a rear carriage machine frame which, together with the joint device described in more detail below which connects these two machine frame parts, form the overall machine frame and thus the main support structure of the construction machine. The construction machine further comprises a drive device, such as an internal combustion engine and/or an electric motor, which provides the drive energy required for traveling and working operation. The construction machine may also have an operator platform, in particular in the form of a driver's cab or the like.

The front carriage and the rear carriage are mechanically connected via an articulated pendulum joint device connecting the front carriage to the rear carriage. Accordingly, said articulated pendulum joint device is a functional unit, usually acting at least partially mechanically, via which the two frame parts can be connected such that the two frame parts can move relative to each other about an articulated joint steering axis and a pendulum joint oscillating axis.

In particular, the articulated pendulum joint device may be configured such that the oscillating movement of the front carriage relative to the rear carriage about the pendulum joint oscillating axis is free at least within a defined oscillating range. However, one or more oscillation stops may be provided which limit the range within which the front carriage can oscillate freely about the pendulum joint oscillating axis relative to the rear carriage. The pendulum joint oscillating axis usually extends in the forward direction of the construction machine, in particular lying in a horizontal plane, so that the front carriage and the rear carriage can compensate for uneven ground relative to each other to at least a limited extent.

The articulated joint steering axis of the articulated pendulum joint device, on the other hand, extends at least essentially in a vertical direction, in particular lying in a vertical plane, especially perpendicular to the pendulum joint oscillating axis. The articulated joint steering axis denotes the axis about which the front carriage rotates relative to the rear carriage when only a steering movement is performed via the articulated pendulum joint device.

An actuating device, for example a steering wheel and/or an operating steering lever or similar, may be provided on the operator platform of the construction machine, via the actuation of which an operator can make a steering input. To drive a steering movement about the articulated joint steering axis to implement this steering input, the articulated pendulum joint device comprises a steering drive controlled by a steering control unit, for example in the form of one or more hydraulic and/or electric actuators, such as one or more hydraulic cylinders.

The construction machine further comprises a crab steering joint device. Unlike the articulated pendulum joint device, the crab steering joint device is configured such that the front carriage can be adjusted translationally relative to the rear carriage, in particular in a virtual horizontal reference plane. The translational adjustment is defined by the front carriage undergoing completely the same displacement relative to the rear carriage (or vice versa). In contrast to the steering adjustment, the front and rear carriages are thus shifted parallel to each other by the crab steering adjustment. This can take place along a linear path of movement or along a curve and/or curved path of movement. The crab steering joint device can thus be used in particular to vary the track of the at least one travel unit arranged on the front carriage relative to the track of the at least one travel unit arranged on the rear carriage. This has proved particularly useful with tandem rollers, as the overall working width of the construction machine can be increased beyond the width of a single drum when viewed in the forward direction. An actuating device, for example a suitable control lever or the like, may also be provided for the crab steering joint device on the operator platform of the construction machine, which the operator can use for crab steering adjustment. To drive the crab steering adjustment or the translational adjustment movement of the front carriage relative to the rear carriage and thus to implement an adjustment input from the operator, the crab steering joint device comprises an adjustment drive controlled by the steering control unit, for example also in the form of one or more hydraulic and/or electric actuators, such as one or more hydraulic cylinders.

The method according to the invention, which is described in more detail below, is particularly suitable for a construction machine of the self-propelled ground compaction machine type. Self-propelled ground compaction machines may in particular be single-drum rollers or tandem rollers. Single drum rollers are characterized by having a, in particular a single, roller drum on the front carriage as a travel unit. This roller drum is usually an essentially hollow cylindrical device, the outer surface of which is either smooth or can be provided with further functional means, for example attached pad feet. On the rear carriage, on the other hand, the travel unit is usually configured as a pair of drive wheels. Tandem rollers, on the other hand, usually have at least one and in particular only one single roller drum on both the front and rear carriage. The roller drum may comprise one or more vibration excitation devices, for example so-called imbalance exciters, which can be used to apply additional vibrations to the roller drum in order to carry out a dynamic compaction process. Instead of a roller drum, a rubber wheel set, usually comprising at least three or more individual wheels arranged coaxially to one another, may also be provided. If only rubber wheel sets are fitted to both the front and rear carriage, the tandem roller is also referred to as a rubber-tired roller. Mixed forms are referred to as combination rollers.

Finally, according to the invention, a steering control unit is provided which controls and/or regulates the adjustment of the articulated pendulum joint device and the crab steering joint device in a manner described in more detail below. In particular, the steering control unit may be configured as a computer device and have a suitable computer program for controlling the method described in more detail below. It can receive the operator's steering commands as input variables and can transmit corresponding control commands to the steering drive and the adjustment drive to control the articulated pendulum joint device and the crab steering joint device. Irrespective of this, it is preferably also possible to perform only an adjustment of the crab steering joint device. There may also be one or more sensors that directly or indirectly detect and/or determine the current steering position, in particular the steering angle, as well as the current crab steering adjustment between the front carriage and the rear carriage, and transmit this information to the steering control unit.

It is now essential that the method according to the invention includes a step a) of adjusting the relative position of the front carriage relative to the rear carriage about the articulated joint axis with the aid of a steering control unit. This adjustment is therefore a steering adjustment to steer the articulated construction machine from a straight ahead travel motion into a left or right-hand turn, for example. In addition to this, in a step b), the steering control unit is to control an adjustment of the relative position of the front carriage relative to the rear carriage via the crab steering joint device. In addition to actuation of the articulated pendulum joint device, the implementation of a user's steering command therefore also includes actuation of the crab steering joint device. In this way, the implementation of a steering command from the user extends beyond a pure angular adjustment of the front carriage relative to the rear carriage about the articulated joint axis to also include a translational adjustment of the front carriage relative to the rear carriage by the crab steering joint device. Specifically, this can mean in particular that the implementation of a steering command from the operator includes an adjustment controlled by the steering control unit of both the steering drive of the articulated pendulum joint device and the adjustment drive of the crab steering joint device. With the aid of this type of steering through a combined adjustment of both the steering position and the crab steering position of the front carriage relative to the rear carriage, in particular the relative position of the centers of gravity of the front carriage and the rear carriage relative to each other and relative to the articulated pendulum joint device and crab steering joint device as a whole can be optimized throughout the steering operation, thereby significantly improving the handling of the construction machine.

Generally, it is possible for steps a) and b) to be carried out and controlled one after the other by the steering control unit to implement a steering command from the operator, wherein the order of steps a) and b) may vary. What is important is that both steps for implementing a steering command from the operator are controlled by the steering control unit. However, it is preferred if steps a) and b) are at least partially performed in parallel during a steering operation. In this case, the translational adjustment via the crab steering joint is thus at least partially simultaneous to the rotational steering movement about the steering axis. In this way, a comparatively uniform adjustment movement of the two frame parts relative to each other is achieved.

It is possible that steps a) and b) are always carried out by the steering control unit when implementing any type of steering movement. However, it is preferred if step b), in addition to step a), is performed only when a defined steering angle is exceeded. Additionally or alternatively, the extent of an adjustment in step b) may depend on a currently existing crab steering adjustment, i.e., a currently existing track offset. The existing track offset refers to the offset of the at least one travel unit on the front carriage relative to the at least one travel unit on the rear carriage in the direction of the rotation axis of the travel units in a virtual horizontal reference plane relative to a so-called zero position, in which the front carriage and the rear carriage have a relative position to each other in which a crab steering adjustment would be possible to the same maximum extent towards both the right and left sides. The zero position therefore refers to a center position between the two crab steering adjustments of the front carriage relative to the rear carriage towards the opposite sides.

The direction of the crab steering adjustment controlled by the steering control unit in a steering direction as part of a steering operation may also vary. Generally, it is preferred if the crab steering adjustment or the direction of the crab steering adjustment is dependent on the steering direction specified by the operator. For example, it may be advantageous if the crab steering adjustment in step b) is performed in the direction of the inside of the curve of a steering turn made in step a). This may be accompanied by an advantageous shift in the center of gravity, as described in more detail below. Additionally or alternatively, this also enables the construction machine to travel smaller curve radii overall. However, it is also possible for the crab steering adjustment in step b) to be performed in the direction of the outside of the curve. In individual cases, and particularly depending on the current terrain situation, this may likewise result in optimized handling of the construction machine.

The criteria according to which, in particular, the extent of the crab steering adjustment in step b) takes place may vary. For example, the extent of the crab steering adjustment performed in step b) may depend on the extent of the steering turn, i.e., the steering angle and, in particular, its amount. In particular, the extent of the crab steering adjustment may increase with the size of the steering angle and vice versa. Accordingly, the greater the steering angle, the greater the crab steering offset. Additionally or alternatively, it has proven to be advantageous if this is done taking into account a center of gravity position of the front carriage and/or the rear carriage, in particular relative to the articulated pendulum joint device or in particular relative to a support axis of the articulated pendulum joint device. Particularly relevant in this context are the centers of mass of the front end and/or the rear carriages and their position relative to each other in a virtual horizontal reference plane.

Further, a support axis extending through the articulated pendulum joint device may be particularly relevant in this context. The support axis is a virtual rotation axis about which the respective frame part (front/rear frame) can rotate in a torque-free manner. Depending on the steering turn, the support axis may be coaxial or parallel to the oscillating axis. When the construction machine is projected into a horizontal reference plane, the support axis thus runs functionally with its longitudinal extension in this reference plane at right angles to the rotation axis of the at least one travel unit. According to an advantageous embodiment of the invention, step b) is carried out such that, when the articulated construction machine is projected into a horizontal reference plane, the center of gravity of the front frame or of the rear carriage in this reference plane is brought closer to or shifted onto a support axis of the articulated pendulum joint device. This embodiment has the advantage that, in particular in the event that the travel units are one or more roller drums and that the articulated pendulum joint device can oscillate freely at least within a defined oscillation range, the weight force load distribution along the contact line of the respective roller drums is kept at least comparatively constant even when cornering and in this way, for example, when cornering the construction machine, which in this case is configured in particular as a tandem roller, practically no grooves or similar surface irregularities are created in the underlying ground despite free oscillation about the oscillating axis.

Additionally or alternatively, the method according to the invention may also include detecting a current lateral inclination of the construction machine, in particular of the front carriage and/or the rear carriage. The lateral inclination in this case refers in particular to the inclination of the construction machine relative to the direction of gravity and not relative to the ground surface, specifically the inclination of the construction machine about its rolling axis, i.e., the displacement of the construction machine starting from a horizontal normal position in relation to a plane running in the vertical direction and transverse to the longitudinal axis of the construction machine. With articulated construction machines, the risk of tipping can increase considerably when cornering, particularly on the outside of the curve, due to the shift in the center of gravity described above. The method according to the invention, according to which a steering movement may be performed in parallel with a crab steering adjustment, can now be used to improve the tipping resistance of the construction machine especially in these operating situations. For this purpose, step b), in particular the extent of the adjustment of the relative position of the front carriage relative to the rear carriage via the crab steering joint device, may be carried out in addition to step a) depending on the current lateral inclination. In this situation, it is generally possible that the crab steering adjustment per se is also adjusted in the direction of the inside of the curve. However, it is preferred for the crab steering adjustment to be performed uphill in relation to the current lateral inclination of the front and/or rear carriages in this case.

It is also possible to configure the steering control unit such that it also performs the above-described combination of steps a) and b) simultaneously depending on the current lateral inclination of the front and/or rear frames and the steering direction and/or the steering radius. In this case, however, it is preferred if the consideration of the individual variables is prioritized in relation to each other, so that the influencing variables are not always considered equally by the steering control unit. In particular, it is advantageous if the lateral inclination is considered as an influencing variable for the extent of the crab steering adjustment with priority over the steering direction and/or the steering radius, at least above a defined lateral inclination threshold, in order to ensure that the tilt stabilization that can be achieved with the aid of the lateral inclination-dependent crab steering adjustment always has priority.

According to a further advantageous embodiment of the invention, a current travel speed of the construction machine is detected, and step b), in particular the extent of the adjustment of the relative position of the front carriage relative to the rear carriage via the crab steering joint device, is carried out in addition to step a) depending on the current travel speed. In particular, the extent of the crab steering adjustment may be greater for the same steering angle at higher travel speeds compared to a travel speed reference value and vice versa. In addition, the steering control unit may further be configured such that it controls the extent of the crab steering adjustment not only depending on the travel speed but also on the aforementioned variables “steering angle”, “lateral inclination” and/or “steering direction”.

It is possible that the self-propelled construction machine comprises a ground working device that can be adjusted between a ground working position and a stowed position. Such ground working devices are devices that influence the underlying ground in some way with one or more functions. Such a ground working device may, in particular, be an edge cutter. Such an edge cutter is used to cut and/or press the edge of an asphalt mat into shape. For this purpose, the edge cutter may have a cutting and/or pressure roller that can be pressed into the asphalt mat and/or pressed onto the asphalt mat. The lower vertical apex of this cutting and/or pressure roller may be located below the lower vertical apex of the respective travel unit. Such edge cutters are therefore only used when the construction machine is traveling along the edge of the asphalt mat in a suitable position, for example. Therefore, if the ground working device is in contact with the underlying ground, it is in the ground working position. From this position, it can be moved, manually and/or motor-driven, into the stowed position in which it does not engage or contact the ground. A crab steering adjustment when the ground working device is in the ground working position can be disadvantageous, so that it is also advantageous if the steering control unit is configured such that it activates and/or deactivates step b) in addition to step a) depending on the current position of the ground working device. In particular, it can be configured such that it excludes performance of step b) in addition to step a) if and as long as the ground working device is in the ground working position. For this purpose, one or more sensors may be provided to detect whether the ground working device is currently in the stowed position and/or in the ground working position.

Generally, the operator may be able to choose between a conventional steering behavior or a conventional steering control of the construction machine and the steering control according to the invention described above when operating the construction machine. For this purpose, the method according to the invention may comprise activating and/or deactivating a conventional steering mode and deactivating and/or activating a steering mode with crab steering adjustment according to the invention. For this purpose, the construction machine may comprise one or more suitable control elements that the operator can use to select a corresponding steering mode.

The method according to the invention may also comprise a suggestion function which provides for outputting a signal to the operator of the construction machine if a supplementary adjustment according to step b) would be advantageous, for example due to a current inclined position of the construction machine. The signal may be output, for example, using a display device, such as an overlay in a control display.

Additionally or alternatively, it may also be provided that, in the event of a crab steering adjustment during step a) in accordance with step b), a corresponding intervention is indicated when the operator implements the steering command. In this way, the operator of the construction machine is informed of the crab steering adjustment during a steering operation and can then decide, for example, whether or not an additional crab steering adjustment should be made in accordance with step b).

The steering commands may be made by an operator. However, the method according to the invention also extends to autonomously driving construction machines in which the steering commands are specified by a computer device, for example.

A further aspect of the invention relates to an articulated construction machine, in particular a self-propelled ground compaction machine. The construction machine according to the invention comprises a front carriage with at least one and in particular exclusively one first travel unit, a rear carriage with at least one second and in particular exclusively one second travel unit, an articulated pendulum joint device connecting the front carriage to the rear carriage with an articulated joint steering axis and with a pendulum joint axis, wherein the articulated pendulum joint device has a steering drive for driving a steering movement about the articulated joint axis. The construction machine further comprises a crab steering joint device for translational adjustment of the front carriage relative to the rear carriage, in particular within a virtual horizontal reference plane, wherein the crab steering joint device has an adjustment drive for driving a translational adjustment movement of the front carriage relative to the rear carriage. Finally, a steering control unit is also part of the construction machine according to the invention. For further details of the articulated construction machine according to the invention, reference is made to the preceding, in particular device-related, features. It is now essential for the invention that the steering control unit is configured to carry out the method according to the invention.

The construction machine according to the invention preferably has a steering angle sensor for detecting a target steering angle and/or an actual steering angle between the front carriage and the rear carriage. Additionally or alternatively, the construction machine may have a lateral inclination sensor for detecting a lateral inclination of the front carriage and/or the rear carriage and/or a travel speed sensor for detecting a target travel speed and/or an actual travel speed of the construction machine. The measured values obtained with one or more of the aforementioned sensors can be transmitted to the steering control unit. For this reason, the steering control unit may be in wired and/or wireless signal transmission connection with at least one of these sensors and may be configured such that step b) is carried out depending on at least one of the measured values transmitted by the at least one sensor, in particular depending on the measured values determined by the steering angle sensor.

### BRIEF DESCRIPTION OF THE DRAWINGS

The invention will be explained in more detail below by reference to the embodiment examples shown in the figures. In the schematic figures:

FIG. 1 shows an articulated construction machine of the tandem roller type;

FIG. 2 shows an articulated construction machine of the single-drum roller type;

FIG. 3 shows a perspective view of an articulated pendulum joint device connecting a front carriage to a rear carriage and a crab steering joint device;

FIG. 4A shows a top view of a construction machine in a straight-ahead position;

FIG. 4B shows a detailed view of the connection area between the front carriage and the rear carriage of the articulated construction machine of FIG. 4A;

FIG. 5A shows a top view of the construction machine of FIG. 4A in a right-hand curve;

FIG. 5B shows a detailed view of the connection area between the front carriage and the rear carriage of the articulated construction machine of FIG. 5A;

FIG. 6A shows a top view of the construction machine of FIG. 5A with additional crab steering adjustment;

FIG. 6B shows a detailed view of the connection area between the front carriage and the rear carriage of the articulated construction machine of FIG. 6A;

FIG. 7 shows the positions of FIGS. 5A and 6A superimposed;

FIG. 8 shows the positions of FIGS. 5B and 6B superimposed;

FIG. 9 shows a top view of a construction machine with, among other things, details of a sensor system;

FIG. 10 shows a graph illustrating a relationship between a steering angle and a crab steering adjustment; and

FIG. 11 shows a flow chart of a method for steering control of an articulated construction machine.

Like parts or functionally like parts are designated by like reference numerals in the figures. Recurring parts are not necessarily designated separately in each figure.

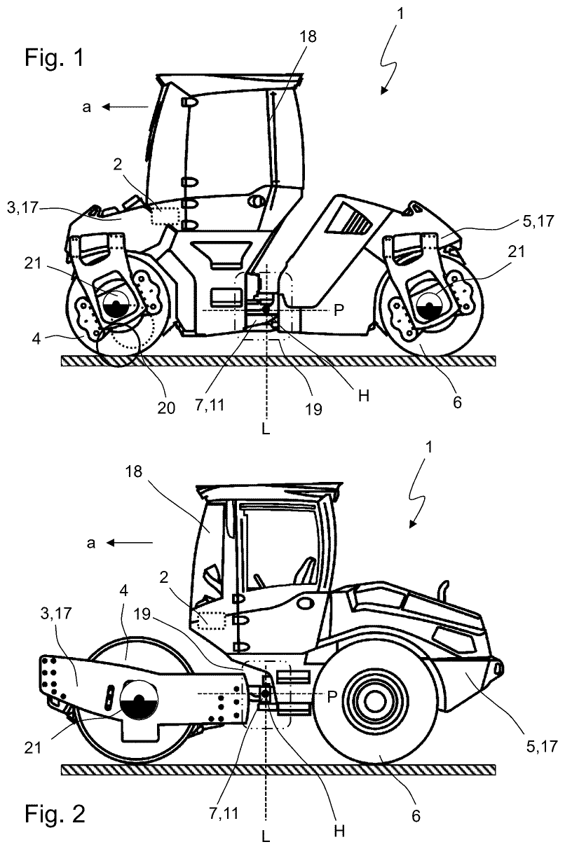

FIGS. 1 and 2 show examples of articulated construction machines 1 in a side view, more specifically FIG. 1 shows a tandem roller and FIG. 2 shows a single drum roller. The two construction machines 1 each comprise an overall machine frame 17 with a front carriage 3 and a rear carriage 5, which are connected to each other via an articulated pendulum joint device 7. A first travel unit 4 (in the embodiments shown in the figures, a single roller drum, which may also be split) is arranged on the front carriage 3 and a second travel unit 6 (in FIG. 1, a single additional roller drum; in FIG. 2, a pair of rubber wheels) is arranged on the rear carriage 5. The forward movement direction of the construction machine 1 is indicated by a. The travel units 4 and 6 may have vibration excitation devices 21, for example in the form of imbalance exciters. The construction machines 1 may also have a ground working device 20, in particular an edge cutter, which can be adjusted between a ground working position and a stowed position. In this context, the construction machine 1 of FIG. 1 shows a cutting and/or pressure roller in the lowered ground working position in contact with the ground with a solid line and in a stowed position raised relative to it and out of contact with the ground with a dotted line.

The construction machines 1 also comprise a drive motor, which is not shown in detail in the figures, and are self-propelled.

They may also have an operator platform, for example in the form of a driver's cab 18. One or more control elements of an actuating device may be provided on the operator platform, via which an operator located on the operator platform can enter traveling and steering commands.

The construction machines 1 also comprise a steering control unit 2. This unit receives one or more steering commands entered by an operator located on the operator platform via one or more of the control elements, for example. The steering control unit 2 is also connected to a steering drive 10, not shown in FIGS. 1 and 2, and an adjustment drive 12 via one or more control lines. In this way, the steering control unit 2 can, among other things, control steering movements of the front carriage 3 relative to the rear carriage 5 about a steering axis L using the steering drive 10. The articulated pendulum joint device 7 also allows the front carriage 3 to be adjusted relative to the rear carriage 5 about an pendulum joint oscillating axis or oscillating axis P extending transversely to the steering axis L of the construction machine 1, at least essentially in the direction of the forward direction a. In the present case, the oscillating axis P extends in the direction of the longitudinal axis of the construction machine 1. This oscillating movement between the front carriage 3 and the rear carriage 5 can take place freely at least within a defined oscillation range and, for example, solely based on the current conditions of the contact surface of the underlying ground for the travel units. A range of this free oscillation may, for example, be in the range of +/−6° starting from a zero position. The articulated pendulum joint device 7 may further include one or more stops that limit the range of free oscillation.

Further, the steering control unit 2 can control a translational adjustment of the front carriage 3 relative to the rear carriage 5, in particular transversely to the axes P and L, i.e., at least partially out of or into the image plane of FIGS. 1 and 2, by controlling an adjustment drive 12 of a crab steering joint device 11 as part of a steering operation. The crab steering joint device may functionally and spatially form a common unit with the articulated pendulum joint device 7 or also, for example, be configured functionally and spatially in series with the articulated pendulum joint device 7. It is essential that the front carriage 3 is connected to the rear carriage 5 by the articulated pendulum joint device 7 and the crab steering joint device 11 such that an adjustment movement of the front frame 3 relative to the rear carriage 5 about the axes P and L and at least partially perpendicular thereto, i.e., transverse to the forward direction a, can be performed. The entirety of the connecting and joint elements that connect the front carriage 3 to the rear carriage 5 is also referred to below as the connecting joint area 19.

As a purely precautionary measure, it is noted at this point that the method described in more detail below for steering control of an articulated construction machine 1 with a steering control unit 2 also extends to autonomously driving or autonomously drivable construction machines 1. These do not necessarily have to have an operator platform. In such a case, the steering commands may be generated by a drive control unit of such a construction machine 1 and transmitted to the steering control unit 2. Alternatively, the steering control unit 2 may also be part of the drive control unit of such a construction machine 1.

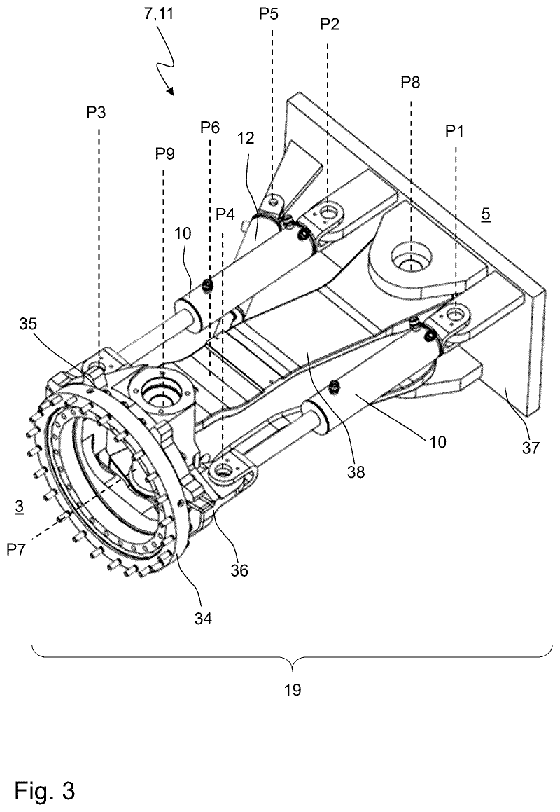

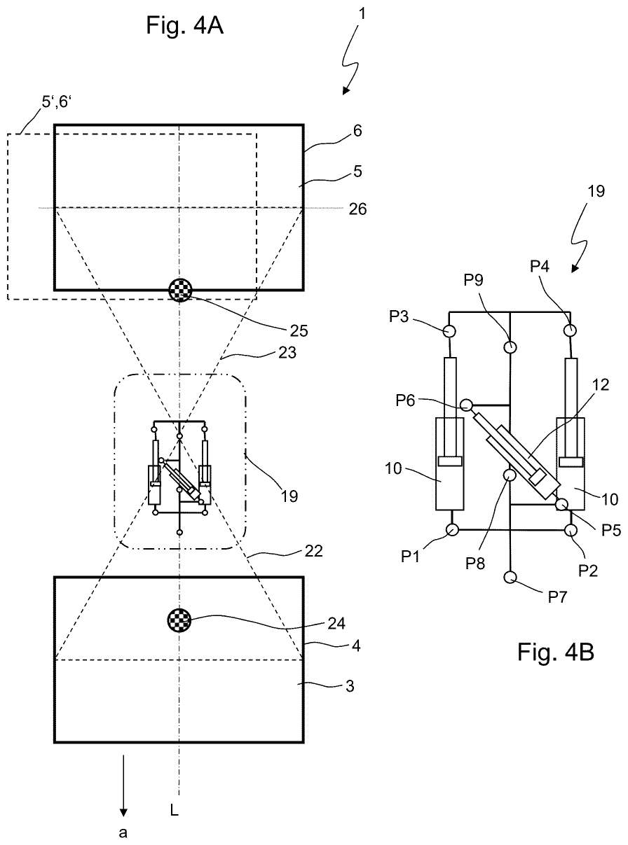

FIG. 3 shows a perspective oblique view of an exemplary articulated pendulum joint device 7 with a crab steering joint device 11. FIG. 3 shows the functionally corresponding hinge points/rotation axes P1 to P9, the steering drive 10 comprising two hydraulic cylinders in this example and the adjustment drive 12 comprising one hydraulic cylinder in this example. The articulated pendulum joint device 7 comprises a rotating ring 34 flange-mounted on the front carriage 3, which is rotatable about the pendulum joint oscillating axis P7 relative to a bearing ring 35 on which a joint support plate 36 is arranged, which in the present example carries bearings for the hinge points P3, P4, P6 and P9. A joint support plate 37 is flange-mounted on the rear carriage 5 on the opposite side. It carries the hinge points P1, P2, P5 and P8. For the load-transmitting connection of the front carriage 3 to the rear carriage 5, the articulated pendulum joint device 7 comprises a connecting support axle 38, which is articulated to P8 and P9. The embodiment example shown in FIG. 4 is merely exemplary and can be varied in many ways. In particular, the oscillating joint obtained via the rings 34 and 35 may also be positioned on the side of the rear carriage 5. Furthermore, variations are obviously also possible with regard to the specific configuration of the mechanically acting components. However, the functional relationship essential for the invention is explained in more detail in the figures below.

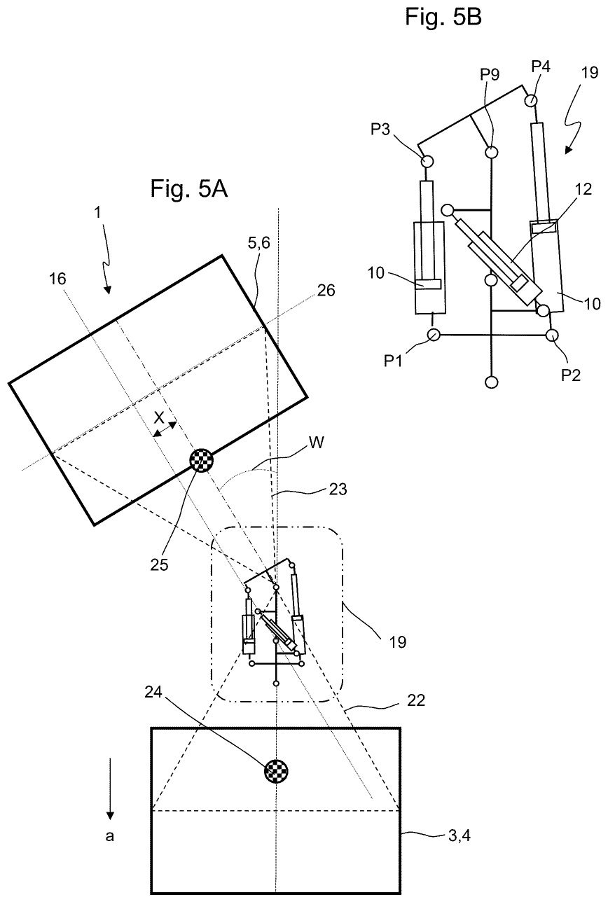

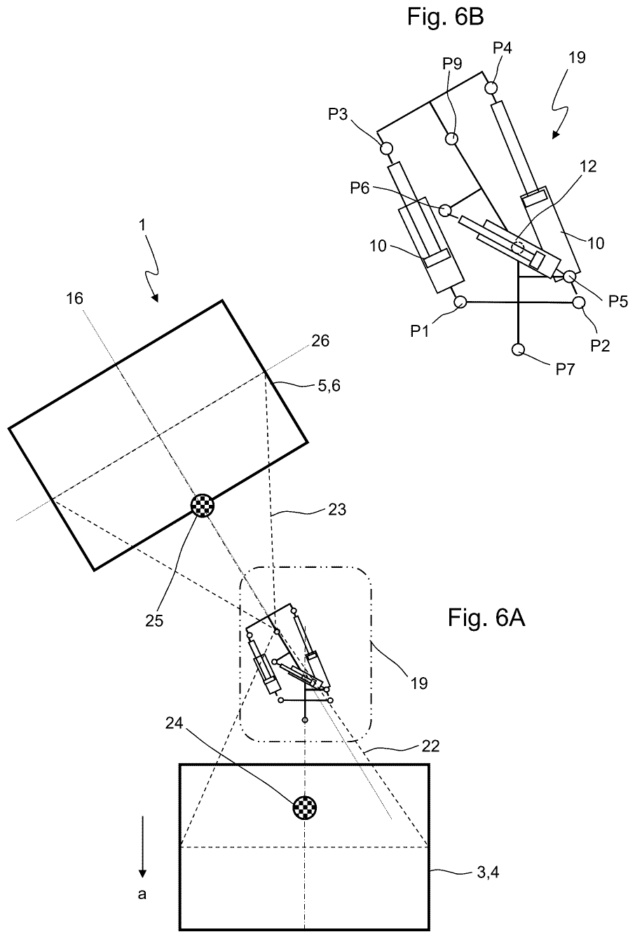

FIGS. 4A, 5A and 6A illustrate an articulated construction machine 1 in a highly schematized form in a top view in various relative positions of the front carriage 3 with the first travel unit 4 relative to the rear carriage 5 with the second travel unit 6. FIG. 4A shows a straight-ahead travel with a crab steering offset of 0. FIG. 5A shows a turn in a right-hand curve (viewed in the forward direction a) with conventional steering based on FIG. 4A. FIG. 6A, on the other hand, shows the turn into the right-hand curve again starting from FIG. 4A with an identical steering angle compared to FIG. 5A, but with a simultaneous compensation adjustment via the crab steering joint device, which is described in more detail below. In FIGS. 4B, 5B and 6B, the connecting joint area 19, comprising the articulated pendulum joint device 7 and the crab steering joint device 11, is shown in a detail view to make the movement behavior of the individual joint devices easier to understand.

The connecting joint area 19 comprises the steering drive 10, which in the present case consists in, for example, a total of two hydraulic cylinders, and the adjustment drive 12, which in the present case also consists in, for example, a hydraulic cylinder. The drives 10 and 12 are each articulated to joint parts via hinge points P, specifically the right hydraulic cylinder seen in the forward direction a via joints P1 and P3, the left hydraulic cylinder seen in the forward direction a via joints P2 and P4 and the adjustment drive via joints P5 and P6. Further, there are an pendulum joint P7 and two crab steering joints P8 and P9. Via the pendulum joint P7, the front carriage 3 can oscillate about the oscillating axis P relative to the rear carriage 5. It will be appreciated that the configuration of the connecting joint area 19 shown in FIG. 4A ff. is merely exemplary and schematic. What is essential is that the functional scope of the connecting joint area 19 includes an articulated pendulum joint device 7 and a crab steering joint device 11. The specific design details for achieving these individual functionalities of the respective joint devices 7 and 11 and their drive may obviously vary.

FIG. 4A also illustrates a load triangle 22 of the front carriage 3 and a load triangle 23 of the rear carriage 5 as well as a center of gravity 24 of the front carriage 3 and a center of gravity 25 of the rear carriage 5. The centers of gravity 23 and 24 are the centers of mass. In the position of the individual elements relative to each other shown in FIG. 4A, a straight-ahead travel is shown in direction a without any crab steering offset, i.e., without any track offset of the front travel unit 3 relative to the rear travel unit 5. Furthermore, FIG. 4A shows an example of the position of the rear carriage 5 or the second travel unit 6 with crab steering offset alone as 6′. In terms of its relative position, the travel unit 6 is offset in position 6′ relative to position 6. This crab steering adjustment is driven solely by the adjustment drive 12. The steering drives 10, on the other hand, do not change their adjustment position. The adjustment drive 12 ultimately achieves a kind of parallel displacement of the rear carriage 5 or its second travel unit 6 relative to the front carriage 3 and its first travel unit 4, thereby causing a track offset. The crab steering adjustment movement takes place within the support force-transmitting joint areas between the front carriage 3 and the rear carriage 5, in particular about the joints P8 and P9. The steering drives 10, which are not retracted or extended in the case of crab steering adjustment alone and therefore do not change their adjustment position, act as parallelogram guides in this case. The translational adjustment movement of the rear carriage relative to the front carriage thus runs along a curve in this case when the construction machine 1 is projected into a virtual horizontal projection plane (for example the image plane of FIG. 4A ff.). However, it is also possible to configure the connecting joint area such that this translational adjustment movement is linear, in particular horizontal and transverse to the pendulum axis P, for example along a guide rail.

Starting from the position shown in FIG. 4A, FIG. 5A shows in comparison a pure cornering movement to the right with the steering angle W. The adjustment drive 12 of the crab steering joint device has not been adjusted compared to FIG. 4A. There was therefore no crab steering adjustment. The steering movement was driven solely by the steering drive 10, specifically by adjusting the two hydraulic cylinders of the steering drive 10. The hinge point of the steering movement is at P9, through which the steering axis L runs in this case. As a result of this steering adjustment, the rear carriage 5 in the present embodiment example is displaced with its center of gravity 25 in the horizontal plane by a distance X from the extension of the support axis 16 of the connecting joint area 19, in the present case specifically the crab steering joint device 11, as a result of which there is no longer a uniform distribution of weight force at the second drive unit 6. If, for example, the travel unit 6 is a drum-shaped roller drum, the weight forces in the contact area of the roller drum with the ground increase from left to right in the illustration in FIG. 5A. This can introduce undesirable irregularities into the ground surface, especially if the underlying ground is comparatively soft.

In addition to the steering adjustment shown in FIG. 5A, according to the invention, the crab steering joint device 11 is now also adjusted, so that the tracks of the travel units 4 and 6 of the front carriage 3 and the rear carriage 5 are offset. This may, for example, correspond to the aforementioned distance X and be used to bring the center of gravity 25 of the rear carriage 5 closer to the extension of the support axis 16 of the connecting joint area 19, specifically, for example, the crab steering joint device 11, even in a cornering situation, or, as illustrated in FIG. 6A, even to shift it to the extension of the support axis 16 in the projection in the horizontal plane. In this case, a uniform weight force distribution of the ground contact area of the at least one second travel unit 6 of the rear carriage 5 in the direction along the longitudinal axis 26 or the rotation axis of the travel unit 6 is also ensured, for example, when the construction machine 1 is cornering.

The extent of the crab steering adjustment shown in FIG. 6A, in this case by the amount X compared to FIG. 5A, does not necessarily have to be selected such that the center of gravity 25 lies on the support axis 16. It is also possible that the center of gravity 25 is only brought closer to the support axis 16 or alternatively shifted beyond the support axis 16 in the sense of overcompensation. These two variants may be particularly advantageous if the construction machine 1 also has a lateral inclination relative to the horizon or relative to the direction of gravity. This may be the case, for example, when traveling on slopes or when working on profiled ground surfaces, such as when working on a road surface with a roof profile. In these cases, for example, it may then be advantageous that the crab steering adjustment, which is carried out together with a steering adjustment to perform a steering operation, is carried out such that the center of gravity 25 is shifted uphill relative to the center of gravity 24.

Depending on the configuration of the connecting joint area 19, it is also possible for the center of gravity 24 to be displaced in the horizontal projection plane from the support axis of the connecting joint area 19 and, in particular, from the crab steering joint device 11, during cornering, instead of the center of gravity 25. In this case, the mechanisms described above may be applied in an analogous manner to a shift in the center of gravity of the center of gravity 24.

It is also possible to carry out the above-described adjustment of both the articulated pendulum joint device 7 and the crab steering joint device 11 one after the other and/or with a time lag to one another. However, to obtain an overall adjustment movement that is as uniform and homogeneous as possible, it is preferred for the crab steering joint device 11 and the articulated pendulum joint device 7 to be adjusted as simultaneously as possible.

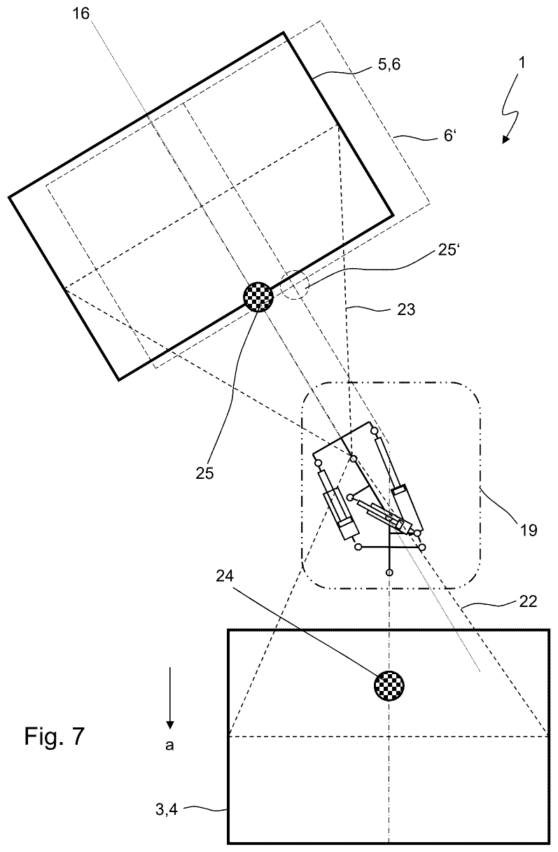

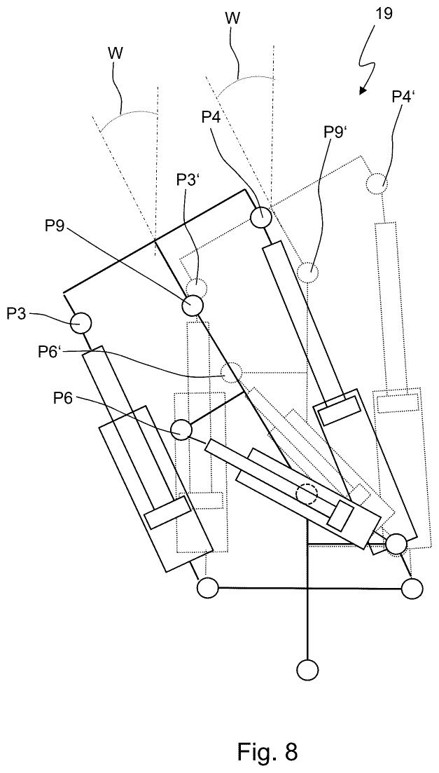

The differences with regard to a possible end position of the exemplary embodiment of the connecting joint area 19 shown in FIGS. 4A to 6B, starting from a straight-ahead travel, between a pure steering adjustment and a steering adjustment combined with a crab steering adjustment, are further illustrated in the superimposed views of FIGS. 7 and 8.

FIG. 7 shows the view of FIG. 6A (steering adjustment and crab steering adjustment) with a superimposed second travel unit 6′ and its center of gravity 25′ of FIG. 5A (steering adjustment without crab steering adjustment). The comparison makes it clear that the additional crab steering adjustment has no influence on the steering angle per se, but does have an influence on the track of the respective travel unit 6. Even if the steering adjustment and the crab steering adjustment can therefore be carried out at the same time, the crab steering adjustment in itself results in a purely translational change in position of the at least one second or rear travel unit 6 of the rear carriage 5 relative to the front carriage 3. In particular, FIG. 7 illustrates the displacement of the center of gravity 25 of the rear carriage 5 relative to the front carriage 3, and in particular also relative to the support axis 16, achieved with the aid of the supplementary crab steering adjustment.

FIG. 8 is a superimposition of FIGS. 5B (dotted lines) and 6B (solid lines) and thus of the enlarged connecting joint areas 19. In this particular embodiment example, the crab steering adjustment of the crab steering joint device thus shifts the hinge points P3, P4, P6 and P9 (the position of these hinge points for the case of a pure steering adjustment are marked with ′ in FIG. 8). However, the steering angles W achieved in each case remain the same in both cases even with the additional crab steering adjustment.

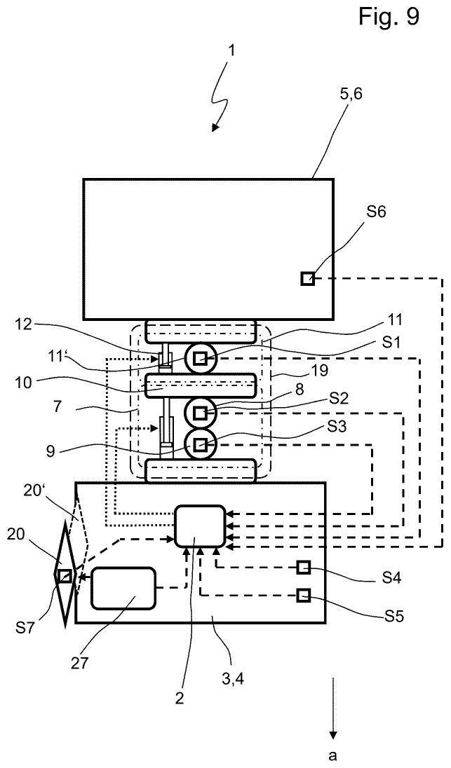

FIG. 9 illustrates in an alternative representation further details, in particular of the exemplary structure of a control system for carrying out a method for steering control of the articulated construction machine 1. For reasons of clarity, the connecting joint area 19 is shown in highly schematized form and functionally comprises the articulated pendulum joint device 7 with the articulated joint axis 8 and the pendulum joint axis 9 as well as the crab steering joint device with a guide device 11′. The steering drive 10 and the adjustment drive 12 are also included.

The crab steering joint device 11 comprises a sensor S1, which is configured to determine and/or monitor the current track offset or the current “crab steering position”. The sensor may be, for example, a displacement and/or position measuring device of the adjustment drive 12.

There is also a steering angle sensor S2, which is configured to determine the current steering angle of the front carriage 3 relative to the rear carriage 5.

The sensor system of the construction machine 1 also optionally comprises an oscillation angle sensor S3, which is not required for the coordination of the steering adjustment and crab steering adjustment to each other, as described in more detail below, but may be used, for example, to determine a lateral inclination of the front carriage 3 relative to the rear carriage 5.

A travel speed sensor S4 may also be provided, which determines the current travel speed of the construction machine 1.

Furthermore, the front carriage 3 may have a lateral inclination sensor S5 and/or the rear carriage 5 may have a lateral inclination sensor S6, which are configured to determine the current lateral inclination of the respective carriage part relative to the horizon or relative to gravity.

Finally, the construction machine 1 may have one or more position detection sensors S7, with which one or more positions of one or more ground working devices 20 that can be adjusted between a ground working position and a stowed position, for example an edge cutter as shown in diamond shape in FIG. 9, can be determined and/or monitored. In FIG. 9, the ground working device 20 is in the ground working position, with 20′ indicating the stowed position.

The sensors S1 to S7 are configured to directly or indirectly determine the aforementioned parameters and, if present, are in signal transmission connection with the steering control unit 2. In addition, the construction machine 1 may have an actuating device 27, for example a driving and steering lever and/or other control elements, via which the operator of the construction machine 1 can manually enter, for example, steering, driving direction and/or driving speed commands. The actuating device 27 and the sensors S1 to S7 may be in signal transmission connection with the steering control unit.

Based on one or more of the values received by the steering control unit 2 from the sensors S1 to S7 and/or the control commands received from the actuating device 27, the steering control unit 2 controls the steering drive 10 and the adjustment drive 12. In particular, this is done such that when a pure steering command is received from the actuating device 27, the steering control unit 2, in addition to actuating the steering drive 10 to implement the steering command with regard to the steering angle desired by the operator, also actuates the adjustment drive 12 of the crab steering joint device and performs an adjustment on the crab steering joint device 11. The crab steering adjustment is thus not performed based on a crab steering command entered separately from the steering command by the operator, but also in response to the steering command.

The extent to which and/or when this crab steering adjustment, which is based on a steering input, takes place may vary. For example, this may be carried out by the steering control unit 2 based on a suitable algorithm and/or one or more characteristic maps. In the simplest case, each steering angle is assigned a defined crab steering adjustment, for example in relation to the steering angle in 1° increments.

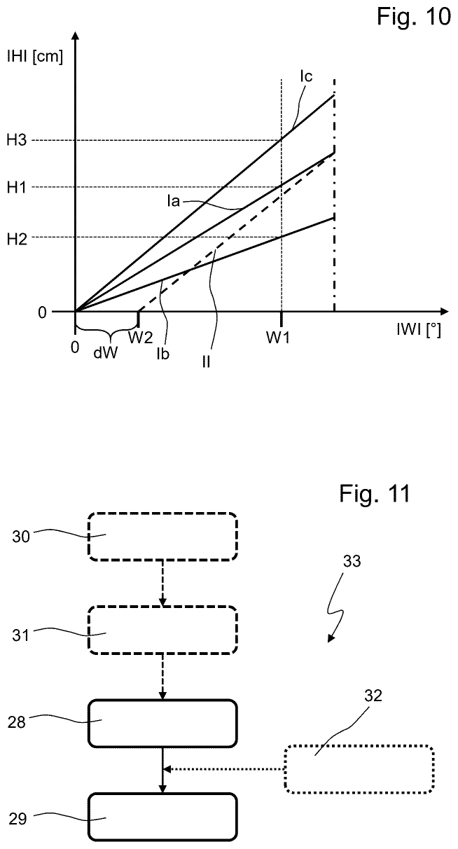

FIG. 10 illustrates various ways in which a crab steering adjustment H may be varied depending on the steering angle W. The abscissa shows the amount of the steering angle W, while the ordinate shows the amount of the crab steering adjustment H. At the zero point there is a steering angle of zero, which corresponds to straight-ahead travel. In the present embodiment example, a crab steering adjustment of zero is also provided as the starting position. This means that the front carriage 3 and the rear carriage 5 are positioned one behind the other in the forward direction a such that the distance of the outer end faces of their respective travel units is the same in the horizontal plane transverse to the forward direction. In other words, they are centered transversely to the forward direction in the horizontal plane. In so-called tandem rollers with one roller drum on the front carriage and one roller drum on the rear carriage, both roller drums, which usually have the same roller width, run in a common track across their entire width. Overall, this relative alignment of the front carriage 3 relative to the rear carriage 5 is also referred to as the zero position.

If a steering movement is made from this zero position in a defined direction, for example to the right, the crab steering adjustment is also performed in a defined direction, for example also to the right. The same applies to a steering movement starting from the zero position to the left, in which case a crab steering adjustment is then made in the direction opposite to the steering movement to the right, i.e., to the left, for example. In other words, the crab steering adjustment shown in FIG. 10 may always take place in the direction of the inside of the curve, depending on the steering adjustment.

The control line Ia provides for a correlation of the steering angle W with the crab steering adjustment, for example such that the center of gravity 25 of the rear carriage 5 remains on the support axis 16 in a virtual projection plane. This may be determined empirically in advance, for example. Furthermore, it is pointed out here as a precaution that this is only an embodiment example. Depending on the configuration of the connecting joint area 19, the center of gravity of the front carriage 3 may also be shifted to the support axis 16 by means of the described crab steering adjustment. What is essential is that the steering mode according to Ia is aimed at maintaining a uniform distribution of weight force over the entire contact width of the at least one travel units and, in particular, of said exclusively one respective travel unit of the front carriage 3 and the rear carriage 5. Steering mode Ia may therefore also be described as “even load distribution”, for example.

The situation is different in steering mode Ib, where the line has a lower gradient. At the same steering angle (e.g. W1), the extent (or amount) of crab steering adjustment or track offset H2 is less compared to H1 in mode Ia. This may be desirable, for example, if the cornering behavior of the construction machine 1 is to be less impaired, but at the same time the advantages of simultaneous crab steering adjustment are to be achieved at least in part. Steering mode Ib may therefore also be referred to as “slight compensation mode”, for example.

Alternatively, in steering mode Ic, which may be referred to as “overcompensation mode”, the crab steering adjustment is even increased compared to Ib, for example to H3 for W1. This may be advantageous, for example, when traveling on slopes or in similar scenarios.

Steering mode II differs from the previous steering modes Ia to Ic in that, starting from the zero position, a threshold value or an adjustment range dW of the steering angle is defined by W2, within which no simultaneous crab steering adjustment takes place yet. Only at steering angles greater than W2 will the steering control unit 2 also initiate a supplementary crab steering adjustment. Additionally or alternatively, it may also be possible for the supplementary crab steering adjustment to only take place up to a certain steering angle W smaller than the maximum steering angle W. This steering mode may be referred to as “threshold mode”, for example.

Further additional or alternative correlations between the steering angle W and the crab steering adjustment H may, for example, also be provided as a function of the travel speed (for example in the sense that, for a same steering angle, the extent of the crab steering adjustment is greater at higher travel speeds than at lower travel speeds) and/or the lateral inclination of the construction machine (for example in the sense that a crab steering adjustment is performed uphill responsive to steering angle and/or lateral inclination changes) and may be controlled by the steering control unit 2. Mixed forms are also possible.

It will be appreciated that the crab steering adjustment depending on the steering angle as described above may be activated and deactivated as an operating function of the construction machine 1. For this purpose, the actuating device 27 may have an input device which can be used to activate and/or deactivate this “steering angle with crab steering adjustment” mode. A selection device may also be provided, with the aid of which the operator of the construction machine 1 can choose between different sub-modes of the compensation mode. These may include modes such as “overcompensation”, “even load distribution”, “tilt resistance”, “speed-dependent compensation”, etc.

Variations are also possible with regard to the actual execution of the two individual movements “steering angle adjustment” and “crab steering adjustment” relative to each other. Generally, it is possible, as shown in the above embodiment examples, for the crab steering adjustment to be carried out simultaneously or in parallel with the steering adjustment. However, it is also possible that the steering movement is prioritized over the crab steering adjustment and the crab steering adjustment associated with the current steering angle W only takes place once the target steering angle has been set. Mixed forms of movement synchronization are also conceivable.

Finally, FIG. 11 illustrates by way of example the sequence of a method according to the invention, in particular using one or more of the embodiments explained and shown in the preceding figures. Step 28 includes adjusting, controlled by the steering control unit 2, the relative position of the front carriage 3 relative to the rear carriage 5 about the articulated joint axis 8, and thus a steering adjustment based on, for example, a steering command given by an operator. Further, step 29 includes adjusting, controlled by the steering control unit, and in particular simultaneously, the relative position of the front carriage 3 relative to the rear carriage 5 via the crab steering joint device 11. Steps 28 and 29 may be preceded by activating such a steering mode according to step 30 and determining the current crab steering and steering position in step 31, for example with the aid of sensors S1 and S2.

The method may further comprise monitoring the position of a ground working device 20 which can be adjusted between a ground working position and a stowed position and, in a step 32, allowing or blocking the crab steering adjustment in addition to the steering adjustment in a position-dependent manner in step 29, in particular such that step 29 is only allowed in step 32 if the ground working device is in the stowed position or at least not in contact with the ground or even engaging the ground. This can be done using one or more of the sensors S7, for example.

What is claimed is:

1. A method for steering control of an articulated construction machine, by means of a steering control unit, the construction machine comprising:
a front carriage with a first travel unit;
a rear carriage with a second travel unit;
an articulated pendulum joint device connecting the front carriage to the rear carriage with an articulated joint steering axis and a pendulum joint oscillating axis, the articulated pendulum joint device having a steering drive controlled by the steering control unit for driving a steering movement about the articulated joint axis;
a crab steering joint device for translational adjustment of the front carriage relative to the rear carriage, the crab steering joint device having an adjustment drive controlled by the steering control unit for driving a translational adjustment movement of the front carriage relative to the rear carriage;
wherein a steering operation controlled by the steering control unit comprises the steps of:
a) adjusting the relative position of the front carriage relative to the rear carriage about the articulated joint axis and
b) adjusting the relative position of the front carriage relative to the rear carriage via the crab steering joint device.

2. The method according to claim 1, wherein steps a) and b) are performed at least partially in parallel to one another during a steering operation.

3. The method according to claim 1, wherein step b) is performed in addition to step a) only when a defined steering angle (dW) is exceeded.

4. The method according to claim 1, wherein the adjustment in step b) is performed in the direction towards the inside of the curve of a steering turn performed in step a).

5. The method according to claim 1, wherein the extent of the adjustment performed in step b) depends on a position of a center of gravity of the front carriage and/or the rear carriage.

6. The method according to claim 1, wherein step b) is carried out such that, when the articulated construction machine is projected into a horizontal reference plane, the center of gravity of the front carriage or of the rear carriage in this reference plane is brought closer to or shifted onto a support axis of the articulated pendulum joint device.

7. The method according to claim 1, wherein a current lateral inclination of the construction machine, in particular of the front carriage and/or of the rear carriage, is detected, and in that step b), in particular the extent of the adjustment of the relative position of the front carriage relative to the rear carriage via the crab steering joint device, is performed in addition to step a) depending on the current lateral inclination.

8. The method according to claim 1, wherein a current travel speed of the construction machine is detected, and in that step b), in particular the extent of the adjustment of the relative position of the front carriage relative to the rear carriage via the crab steering joint device, is performed in addition to step a) depending on the current travel speed.

9. The method according to claim 1, wherein the self-propelled construction machine comprises a ground working device (20), in particular an edge cutter, which can be adjusted between a ground working position and a stowed position, and in that the steering control unit, in addition to step a), activates and/or deactivates step b) depending on the current position of the ground working device (20).

10. An articulated construction machine comprising:
a front carriage with a first travel unit;
a rear carriage with a second travel unit;
an articulated pendulum joint device connecting the front carriage to the rear carriage with an articulated joint steering axis and a pendulum joint axis, the articulated pendulum joint device having a steering drive for driving a steering movement about the articulated joint axis;
a crab steering joint device for translational adjustment of the front carriage relative to the rear carriage, the crab steering joint device having an adjustment drive for driving a translational adjustment movement of the front carriage relative to the rear carriage; and
with a steering control unit, wherein:
the control device is configured for carrying out the method according to claim 1.

11. The articulated construction machine according to claim 10, comprising:
a steering angle sensor for detecting a target steering angle and/or an actual steering angle between the front carriage and the rear carriage;
a lateral inclination sensor for detecting a lateral inclination of the front carriage and/or the rear carriage and/or a travel speed sensor (S4) for detecting a target travel speed and/or an actual travel speed; and
wherein the steering control unit is in signal transmission connection with at least one of these sensors and is configured such that step b) is carried out as a function of at least one of the measured values transmitted by the at least one sensor.
